(19) United States
(12) Patent Application Publication
(10) Pub. No.: US 2009/0325757 A1
(43) Pub. Date: Dec. 31, 2009

(54) AUTOMATIC TRANSMISSION

(75) Inventors: Patrick DROMARD, Heiligenstein (FR); Vincent HOLTZ, Rosenwiller (FR); Pascal TISSOT, Gerstheim (Basrhin) (FR); Nicolas DISS, Strabourg (FR)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/493,006

(22) Filed: Jun. 26, 2009

(30) Foreign Application Priority Data
Jun. 27, 2008 (GB) 0811776.4

(51) Int. Cl. F16H 61/14; F16H 45/02

(52) U.S. Cl. 477/62; 192/3.28

(57) ABSTRACT

An automatic transmission is provided with a torque converter clutch (TCC) for regulating the slip between the engine speed and the transmission input speed and a method is provided for regulating the slip between the engine speed and the transmission input speed in an automatic transmission with a torque converter clutch. In order to improve the first time shift quality of transmissions, it is proposed that means are provided for learning the valve pressure offset. In first tests it could be stated that the first time shift quality can be considerably improved with a short test which takes place at the end of the vehicle production line. The longer the test time, the better the first time shift quality will be.

### CROSS-REFERENCE TO RELATED APPLICATION

This application claims priority to British Patent Application No. 0811776.4, filed Jun. 27, 2008, which is incorporated herein by reference in its entirety.

### TECHNICAL FIELD

The invention relates an automatic transmission with a torque converter clutch (TCC) for regulating the slip between the engine speed and the transmission input speed and a method for regulating the slip between the engine speed and the transmission input speed in an automatic transmission with a torque converter clutch.

### SUMMARY

In cars with automatic transmission, a torque converter clutch (TCC) is placed between the engine and the input of the transmission. It regulates the slip between the engine speed and the transmission input speed. This slip speed depends on the driving conditions: if it is high, engine torque oscillation is well filtered, if it is low, the fuel consumption is low too, and if it is zero, the performance of the car is at its maximum.

The transmission control unit (TCU) calculates the TCC pressure in function of the torque and of the target slip. The actual pressure must be as much as possible equal to the command. A little gap is rapidly corrected by the adaptation and does not affect the TCC behavior. If the gap is more important, the adaptation takes a lot of time and the TCC behavior is deteriorated during this time: if there is too much pressure compared to the command, the extra capacity will lead to a sticky TCC (which means TCC chuggle in coast—zero throttle driving, non-responsive car at low engine speed in drive) and if there is a lack of pressure, the TCC will be too loose with slip-bump as secondary effect in case of throttle tip in.

These problems mainly affect the first time shift quality of a part of the produced transmissions as the adapt centering means which put the nominal TCC offset value as the default calibration is not sufficient for a part of the produced transmissions. For these transmissions, the electronically controlled converter clutch (ECCC) which controls electronically the TCC slip is under the level of the expected performance.

Several features have been developed to compensate this problem. In a first approach, a function called “TCC Immediate Off Low Torque” was developed in order to avoid the TCC chuggle phenomenon in coast. The chuggle is fixed by releasing the TCC (Off Mode), but the ECCC coast performance expected was not met. In a second approach, it was tried to re-adjust the TCC-VBS conversion table calibration based on the transmissions that have a minimum TCC offset. This solves the ECCC coast performance and the chuggle problems for the transmissions that have a minimum TCC Offset (marginal but negligible quantity), but here again, the ECCC performance was deteriorated for transmissions with a nominal TCC offset which is the majority of the production.

It is at least one objective of the invention to improve the first time shift quality of transmissions. In addition, other objectives, desirable features, and characteristics will become apparent from the subsequent summary and detailed description, and the appended claims, taken in conjunction with the accompanying drawings and this background

### SUMMARY

According to the invention, this objective, other objectives, desirable features, and characteristics is achieved by an automatic transmission with a torque converter clutch for regulating the slip between the engine speed and the transmission input speed in that means for learning the TCC valve pressure offset are provided.

The invention is based on the consideration that it is possible to take advantage of the engine torque regulation used to control the idle speed. In the first gear when the transmission output is not rotating, if the TCC starts to have capacity (which means that the valve offset has just been reached), it will brake the engine as the turbine is not rotating. The engine will compensate the brake torque by increasing its torque to keep the idle speed constant. It is therefore possible to use an engine torque detection to learn the valve bleed solenoid (VBS) command corresponding to the valve pressure offset.

In the first tests it could be stated that according to an embodiment of the invention the first time shift quality can be considerably improved with a short test (a few seconds) which takes place at the end of the vehicle production line. The longer the test time, the better the first time shift quality will be.

In a preferred embodiment of the invention, the means are configured to learn the valve pressure offset in terms of commanded valve bleed solenoid (VBS) pressure at several line pressure levels.

A method for regulating the slip between the engine speed and the transmission input speed in an automatic transmission with a torque converter clutch in which the valve pressure offset is learned is also within the scope of the invention.

The method of the invention comprises the following steps: setting of a line pressure, checking the test conditions, when the test conditions are fulfilled, commanding a ramp on the TCC VBS pressure while measuring the engine torque, measuring the TCC VBS pressure at the moment when the engine torque starts to increase.

An improvement according to the invention lies in the fact that the default value (which corresponds to an average value of a sample of transmissions) is overwritten by a corrected value taking into account the measured TCC VBS pressure.

According to an embodiment of the invention, the test conditions comprise that the selector lever is in drive position, the first gear is engaged, the transmission output speed is zero rpm (standstill), a preset minimum pressure on the brake pedal is reached, a preset minimum transmission temperature is reached (for friction repeatability), a preset minimum engine temperature is reached and that the air conditioning compressor is stable (on or off).

### BRIEF DESCRIPTION OF THE DRAWINGS

The present invention will hereinafter be described in conjunction with the following drawing figures, wherein like numerals denote like elements, and

FIG. 1 shows a schematic presentation of the situation; and

FIG. 2 shows a graph for the determination of the valve pressure offset.

### DETAILED DESCRIPTION

The following detailed description is merely exemplary in nature and is not intended to limit application and uses. Furthermore, there is no intention to be bound by any theory presented in the preceding background and summary or the following detailed description.

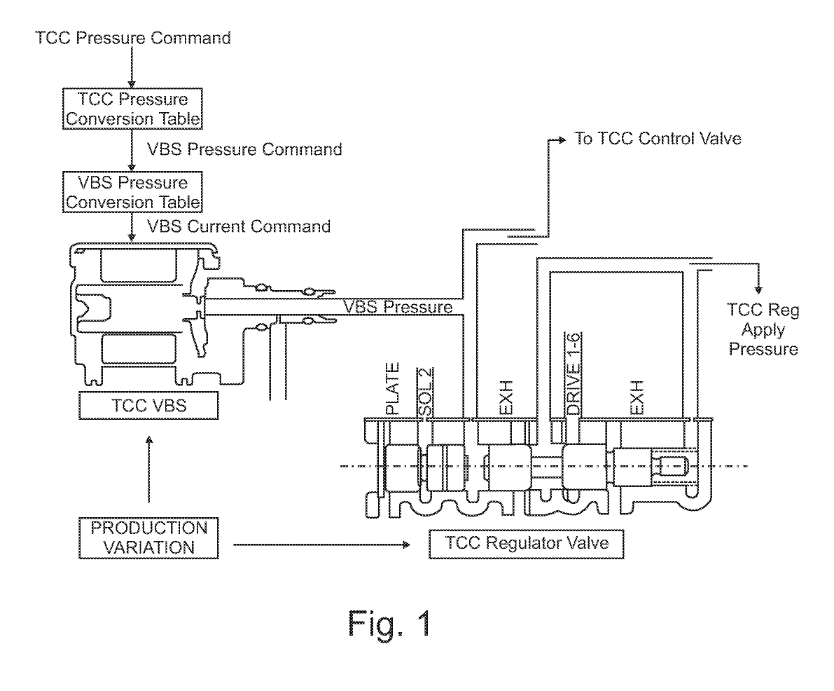

Due to production variation, a dispersion of the TCC pressure offset in new transmissions can be stated which means that the amount of VBS pressure necessary to start having capacity in the clutch varies among the transmissions of the same type. The dispersion is mainly due to the TCC regulator valve offset variations and to the tolerance of the pressure delivered by the VBS as shown in FIG. 1.

According to an embodiment of the invention, the valve pressure offset in term of the commanded VBS pressures at different line pressure levels is determined and a TCC-VBS pressure conversion table is dressed having on its x-axis the TCC command and on its y-axis the VBS command.

Then, the fulfillment of the following test conditions is checked: the selector lever is in drive position, the first gear is engaged, the transmission output speed is zero rpm (standstill), a preset minimum pressure on the brake pedal is reached (as for neutral idle function), a preset minimum transmission temperature is reached (for friction repeatability), a preset minimum engine temperature is reached and that the air conditioning compressor is stable (on or off).

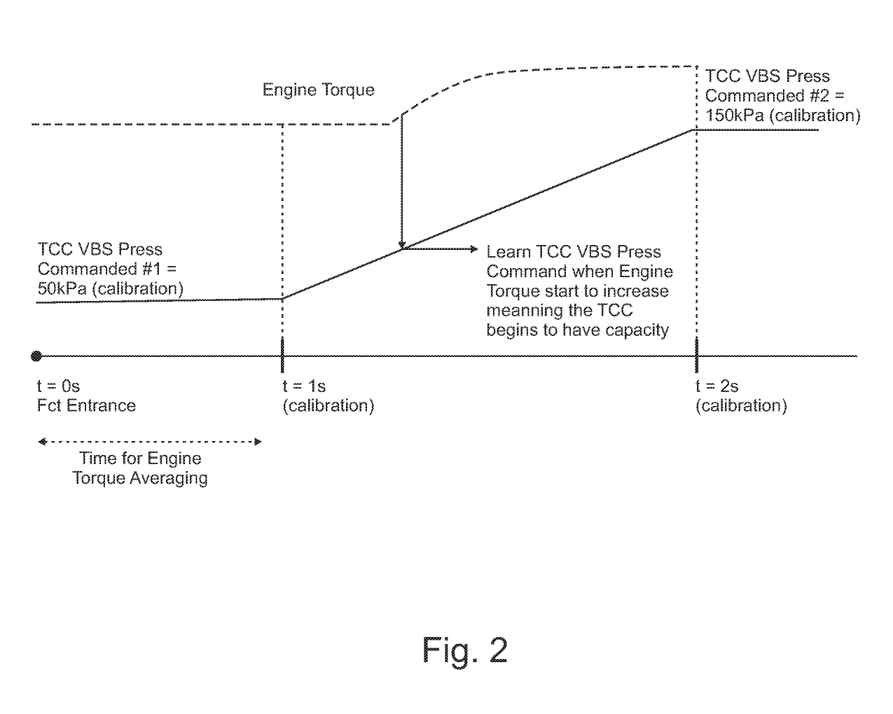

If these test conditions are fulfilled, the engine torque is checked and a ramp is commanded on the TCC VBS pressure as shown in FIG. 2. In the example of FIG. 2, the ramp starts at a TCC VBS pressure of about 50 kPa and ends at a TCC VBS pressure of about 150 kPa and it lasts about 1 second. The engine torque is measured and the TCC VBS pressure is determined where the engine torque starts to increase which corresponds to the fact that the TCC begins to have capacity. As can be seen from FIG. 2, the complete determination lasts about 2 seconds to 3 about seconds. The lower the ramp is, the more accurately the TCC VBS pressure can be determined, but in the same time, the test duration increases. It has been found that within about 2 seconds to about 3 seconds, it is possible to learn the TCC pressure offset precisely enough in order to have about 70% of the TCC performance during the first time shift quality.

The default value (average of a sample of transmissions) is then overwritten by the learned value minus a calibrated value and the corresponding row will be offset by the difference between the learned value and the default value minus the calibrated value.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An automatic transmission, comprising:
a torque converter clutch (TCC) adapted to regulate a slip between an engine speed and a transmission input speed; and
means for learning a valve pressure offset of the TCC.

2. A method for regulating a slip between an engine speed and a transmission input speed in an automatic transmission with a torque converter clutch comprising the step of learning a valve pressure offset.

3. The method of claim 2, wherein learning the valve pressure offset comprising the step of learning the valve pressure offset in terms of a commanded valve bleed solenoid (VBS) pressure at a plurality of several line pressure levels.

4. The method of claim 3, further comprising the steps of:
setting of a line pressure;
checking a test condition;
commanding a ramp on a TCC VBS pressure while measuring an engine torque when the test condition are fulfilled; and
measuring the TCC VBS pressure at a moment when an engine torque starts to increase.

5. The method of claim 3, further comprising the step o overwriting a default value with a corrected value taking into account a measured TCC VBS pressure.

6. The method of claim 3, wherein a test condition comprise a selector lever is in drive position, a first gear is engaged, a transmission output speed is zero rpm (standstill), a preset minimum pressure on a brake pedal is reached, a preset minimum transmission temperature is reached, a preset minimum engine temperature is reached and an air conditioning compressor is stable (on or off).
